(19) United States
(12) Patent Application Publication
(10) Pub. No.: US 2006/0040040 A1
(43) Pub. Date: Feb. 23, 2006

(54) Device for ozone treatment of plant materials

(76) Inventors: Christian Coste, Loriol Du Contat (FR); Alain Bailli, Menucourt (FR); Michel Dubois, Buc (FR)

Correspondence Address: DENNISON, SCHULTZ, DOUGHERTY & MACDONALD, 1727 KING STREET, SUITE 105, ALEXANDRIA, VA, 22314, US

(21) Appl. No.: 10/528,768

(22) PCT Filed: Sep. 26, 2003
(86) PCT No.: PCT/FR03/02831

§ 371 Date: Mar. 22, 2005

(30) Foreign Application Priority Data
Sep. 27, 2002 (FR) 02/11970

(51) Int. Cl. A21D 2/00

(52) U.S. Cl. 426/622

(57) ABSTRACT

The present invention relates to a novel process for the ozone treatment of unground plant materials such as wheat grains. According to the invention, this process consists in allowing the plant material to stand for at least one day after a prehumidification followed by an ozonization involving a complementary humidification that adds from 3 to 10% by weight of water, based on the dry weight of the plant material. This process is applied especially to wheat grains. In this case, a process according to the invention that enables the ozone to reach the core of the grains is carried out in order to manufacture so-called “technological” flours. The physical and chemical properties of such flours, observed as a function of the parameters of the ozonization process, are presented.

The present invention relates to a novel process for the ozone treatment of plant materials comprising, in particular, wheat, other cereals and Leguminosae. This ozone treatment process can be carried out especially with a view to the manufacture of so-called “technological” flours from soft wheat grains. These are flours whose physical and/or chemical properties have been chosen to satisfy certain criteria required for their subsequent use in the bread and pastry industries. This process can also be carried out with a view to the manufacture of semolinas and pastas from hard wheat grains.

### TECHNOLOGICAL BACKGROUND

A number of physical and chemical properties are particularly sought after for the flours used in the cereal cooking industry. These properties are very desirable not only because of the ease of use they generate and the low cost they give rise to in the industrial manufacturing process, but also because of the quality they bring to the product in question.

These properties must satisfy the following demands in particular:

a) Frozen bread producers are using ever-faster kneading processes which demand flours with accelerated hydration.

b) The mechanical properties of the doughs manufactured from the flours must have particular characteristics which are of decisive importance for the formation and structure of the product obtained after baking. These main characteristics are tenacity, extensibility, tolerance and porosity during development.

Tenacity and extensibility relate to doughs intended for conventional bread making and have an important influence on the development and structure of the bread after baking, as well as on the workability during the kneading and shaping process.

Tolerance is the ability of the dough to adapt to different manufacturing processes.

Porosity relates especially to so-called “high ratio” English cakes and to Genoese cakes, where the nascent alveolar structure is of prime importance for development and behavior during the baking process (continuous and homogeneous swelling without collapsing after baking).

c) It is desirable to inactivate some of the enzymes naturally present in the flour, on the one hand in order to control the reactions that produce colored substrates, and on the other hand in order to improve the general conservation properties of the product. The enzymes particularly involved in the color of the crumb are polyphenol oxidase and lipoxygenase. As regards keeping properties and, in particular, lipid oxidation (the cause of rancidity), the main enzyme involved is lipase.

In the state of the art, a number of treatment methods have been described which make it possible to satisfy one or more of the criteria sought after for flours. However, these methods have been applied essentially to flours and not to unground grains.

Thus, chlorine and its derivatives, particularly chlorine dioxide, as well as bromine and its derivatives, have been used to treat flours in order to give them specific properties. These treatments have been used especially in the United States, Great Britain and the Scandinavian countries. These processes, although very useful for industrial producers of products of the “English cake” and “Genoese cake” type, are now subject to a legislative ban, especially in Europe. The producers of these products are therefore forced to look for other solutions, given the unsuitability of the conventional soft wheat flours for the manufacture of their products.

To deal with the adaptation of flours to certain manufacturing processes, millers are accustomed to incorporating certain additives in order to modify the behavior of the dough manufactured from conventional flours. For example, the addition of amylases can lead to an improvement in the volume of the product obtained after baking, to better hydration of the flour during wetting and kneading, and to reduced staling of the finished product, these characteristics being directly linked to partial hydrolysis of the flour starch by amylases.

Likewise, the addition of ascorbic acid to flour makes it possible to improve the tenacity of the dough.

However, there is an increasing demand on the part of consumers to reduce the number of additives in flour. Consequently, although affording an improvement in some physicochemical properties, the use of amylases and ascorbic acid is far from totally satisfactory.

A novel type of treatment, not based on the incorporation of additives, is heat treatment. Heat treatments make it possible to deactivate the gluten, i.e. to prevent the formation of the gluten network. These methods also modify the starch by pregelatinizing it to a greater or lesser degree. They therefore make it possible to control certain physical and chemical properties of the flours.

However, heat treatments are not the perfect solution to the flour users' demands since they have various disadvantages that prevent optimum use for the applications in question. In particular, they consume very large amounts of energy and do not easily allow a homogeneous treatment throughout the mass of the treated flour (existence of a temperature gradient in the mass of the flour during treatment). The manufacture of flours for the cereal cooking industry therefore is associated with a number of problems to which no process described hitherto offers an entirely satisfactory solution.

### SUMMARY OF THE INVENTION

The Applicant has now discovered, surprisingly, that the treatment of unmilled wheat grains with ozone under certain conditions offers a very satisfactory solution to these problems by providing flours that meet various desired criteria of physical and chemical properties while at the same time offering a bacteriological and sanitary quality of flours that the existing techniques cannot offer.

As will be explained below, the Applicant's studies demonstrate that the ozone treatment conditions according to the present invention enable the ozone to penetrate to the core of the tissues, or even the cells, of an unground plant material in which these structures (tissues, cells) are still intact.

Under these conditions, therefore, the ozone can react directly with biomolecules contained in these tissues or cells, such reactions not taking place when unground plant materials are treated with ozone by methods previously described in the prior art.

In the present description, the studies presented relate in particular to the ozone treatment of wheat grains. However, application of the process presented here to plant materials other than wheat is envisaged. Plant materials that can be used in this process include the grains of cereals other than wheat, such as maize, barley, rye and triticale. Application of this process is also envisaged in the case of plant materials including leguminous plants, such as soya, pea, carob and guar, as well as other species such as flax and Cruciferae (cabbages, colza, mustard). In the case of leguminous plants, modification of the proteins inside tissues or cells can have manufacturing advantages after the extraction of specific products containing the modified proteins.

According to a first feature, the aim of the present patent application is to cover a process for the ozone treatment of unground plant materials which comprises at least the following steps:

a) prehumidification of said plant material by the addition of a volume of water;

b) a rest phase for said humidified plant material;

c) exposure of said plant material to ozone,

said process being characterized in that said rest phase has a duration greater than or equal to 1 day, in that the ozone treatment is carried out with a dry ozone-containing gas, and in that it comprises a complementary humidification carried out simultaneously with, or at most 10 minutes before, said exposure to ozone under conditions that make it possible to add from 3 to 10% and preferably from 3 to 5% by weight of water to said plant material, based on the dry weight of the material.

Thus, to achieve the desired object, it has been found that the following two conditions, which constitute the novelty of this process, must be met:

i) Between the prehumidification of the plant material treated and the ozone treatment, there is a rest phase with a duration of at least 1 day.

ii) At the time of the ozone treatment, an amount of complementary water is added to the material, this amount being from 3 to 10% by weight, based on the dry weight of the plant material.

More particularly, the plant material will preferably comprise grains of either soft or hard wheat.

### BRIEF DESCRIPTION OF THE FIGURES

The invention will be understood more clearly from the following explanatory description referring to the attached Figures, in which:

FIG. 1 is a histological section of the wheat grain at the periphery, showing the 3 main layers (pericarp, aleuron layer and albumen) and the simplified modes of action of the ozone according to whether the dry or wet working method is used.

FIG. 2 represents the impact of the ozone dose on the alveogram obtained by means of the Chopin-Dubois alveograph, all the other parameters of the process being equal.

The curve identified by 1 corresponds to a conventional, well-balanced flour not treated with ozone.

The curve identified by 2 corresponds to a dough obtained from flour derived from grains pretreated with ozone and having a higher tenacity and a lower extensibility than the dough identified by 1.

Curves 3 and 4 correspond to the alveogram of doughs obtained from flours derived from grains which have been pretreated with an increasing dose of ozone and/or whose humidification has been varied. These curves are entirely illustrative of the action of ozone on the tenacity parameter as well as the extensibility parameter.

Curve 5 corresponds to a dough manufactured from so-called “technological” flour derived from grains which have been pretreated with ozone under the optimal conditions of protein modification. Curve 5 corresponds specifically to the theoretical curves sought for the manufacture of so-called “high ratio” English cakes. This curve has a maximum tenacity equal to or greater than 150, and a minimum extensibility.

FIG. 3 represents the impact of the proportion of broken grains on the change in the P/L ratio obtained by means of the Chopin-Dubois alveograph. To do this, the Applicant broke a variable percentage of the grains, added these grains to unbroken grains and then treated the whole with constant doses of ozone. The flours obtained after milling were tested by means of the Chopin-Dubois alveograph and the P/L ratio was calculated.

FIG. 4 represents the impact of ozone treatment on the viscosity of a solution containing flour in a well-defined solids concentration, as a function of time and according to a process of temperature rise, stabilization and then cooling.

This Figure shows two curves corresponding to a normal, untreated flour and a flour treated according to the parameters claimed in the present patent application.

FIG. 5 represents the impact of the pH of the complementary humidifying water in the grains on the viscosity of a flour obtained from grains treated by a deep-acting process, this viscosity being studied by the RVA method in the same way as for the experiments represented in FIG. 4.

The curves showing the variation in viscosity relate to two characteristic varieties of soft wheat, variety 1 being soft wheat of the Courtot type, i.e. a strong wheat, and variety 2 corresponding to a wheat of the Shango type, i.e. a common soft wheat suitable for bread making. The control corresponds to a mixed wheat for ordinary bread making.

### GENERAL DESCRIPTION OF THE INVENTION

In a previous patent application published under no. WO 01/43556, the Applicant has already described the use of ozone in the treatment of soft wheat grains for flour manufacture.

Said patent application describes a chamber for the treatment of grains with ozone which can be used within the framework of the present invention. However, in said earlier patent application, studies relating to the effects of an extended rest period between the prehumidification and the ozone treatments, and studies relating to the effects of the addition of “complementary” water at the time of the ozone treatment, were neither carried out nor suggested.

Although it must not be interpreted as limiting the field of application of the present invention, the Applicant proposes the following explanation of the results it observed with the process according to the invention.

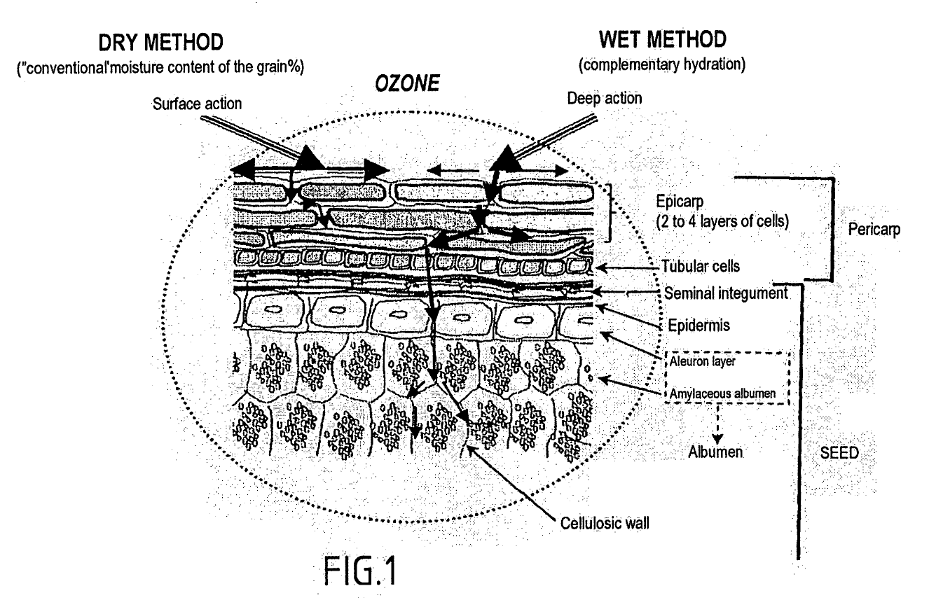

A typical ozonization process, as would be performed by those skilled in the art carrying out the described process in advantageous ranges of values of patent application WO 01/43556, where the ozone is employed in particular to assure sanitary and bacteriological safety, leads to a surface action of the ozone on the grain. Now, within the framework of the present invention, the ozone can effect modifications deep in the wheat grain. Penetration of the ozone to the core of the grain, by virtue of the particular conditions of the present invention, enables this reactive molecule to act on the proteins (gluten), starch, enzymes and pentosans. The effect of the ozone on and in the wheat grains can be summarized by FIG. 1. FIG. 1 is a histological section of the wheat grain at the periphery, showing the 3 main layers (pericarp, aleuron layer and albumen) and the simplified modes of action of the ozone according to whether the dry or wet working method is used.

The dry method corresponds to the ozone treatment of a wheat grain whose moisture content is consistent with the natural humidity when it is harvested or stored (between 13 and 15% of moisture, based on the total weight). In this case the ozone acts preferentially at the periphery of the grain and will therefore have a surface action (reaction with all the chemical or organic compounds present on said surface). The penetration of the ozone inside the grain is very low.

The wet method corresponds to the ozone treatment of a wheat grain which has undergone a complementary hydration in accordance with the data and treatment parameters of the process described in the present patent application. In this case the ozone has a deep action, reacting with the components of the 3 layers described above.

The Applicant considers that the longer the rest period, i.e. the time elapsing between the prehumidification and the ozone treatment phase (also called “conditioning time”), the more the moisture penetrates the grain, dilates the micropores and favors ducts for rapid exchanges and for ozone penetration inside the grain.

The dilation of these micropores (cf. FIG. 1) is of prime importance for the progress of the chemical reactions generated by the ozone inside the grain. The dilation of the micropores, the creation of reactive ducts and the presence of moisture and consequently of a microfilm of water inside these pores favor the gas-solid exchange and the deep action of the ozone in the grain.

The Applicant has observed that a 24-hour rest period between the prehumidification phase and the ozone treatment phase is the minimum that suffices for the majority of target applications. However, this period can be modified according to the varietal species of wheat, or the quality of the wheat, which it is desired to treat.

In parallel with this, the Applicant's studies have shown that the addition of water to the grains at the actual time of ozonization, or at most 10 minutes beforehand, is essential for the ozone to act at the core of the grain.

The nature of the wheats, coupled with their varietal species, is such that the constitution of the peripheral layers differs from one variety to the next, thereby inducing different water penetration kinetics from one variety to the next.

The process of the invention is also perfectly suited to the manufacture of products by the grinding of hard wheat grains (semolinas or flours).

The Applicant has in fact discovered, surprisingly, that the ozone treatment according to the invention is valuable not only for soft wheat grains but also for hard wheat grains. The hard wheat product line comes up against numerous problems which are different from those affecting the soft wheat product line and which have not yet found entirely satisfactory solutions:

a) Hard wheat is very heavily contaminated with mycotoxins and especially with DON (deoxynivalenone), said contamination resulting from the affinity of fungi of the genus Fusarium for hard wheat.

b) Controlling the color of semolinas presents particular problems:
1. The normal yellow color of semolinas can be bleached by the natural lipoxygenase, causing the consumer to reject these bleached semolinas.
2. On the other hand, PPO (polyphenol oxidase), which, like lipoxygenase, is naturally present in hard wheat, has a tendency to brown semolinas, again causing the consumer to reject them.

The Applicant has discovered that the treatment of hard wheats with ozone makes it possible to manufacture flours and semolinas in which inhibition of the lipoxygenase and the polyphenol oxidase allows maximum preservation of the yellow coloration sought for semolinas, and to avoid any possibility of subsequent browning. Of course, the more the ozone is able to penetrate inside the grain, the greater will be the inhibition of these enzymes.

### DETAILED DESCRIPTION OF THE PROCESS OF THE PRESENT INVENTION

The conditions under which flours having the desired physical and chemical properties can be manufactured by the treatment of wheat grains will be specified below.

After harvesting and storage, the wheat grains have a natural moisture content of between 13 and 15%, depending on the climatic conditions of the harvest. The moisture content of the grains can be measured by various methods well known to those skilled in the art, involving e.g. automatic NIR (near infrared) analyses.

The first step in the manufacture of flours from such grains is a so-called prehumidification step referred to as “conditioning” by those skilled in the art. The purpose of this step, which is necessarily preceded by a step for cleaning and for the removal of dusts and foreign bodies, for example by blowing, sieving etc., is to increase the moisture content of the grains to about 16 to 18%. In general, the water added within the scope of the prehumidification of the grain prior to the ozone treatment makes it possible to increase the moisture content of the grains by a value preferably of between 3% and 5%, based on the dry weight of the grains. The prehumidification gives the grains particular properties, both during the ozone treatment and during grinding.

The prehumidification is carried out with a source of water, preferably drinking water. The water used for the prehumidification is preferably free of oxidizing agents, so it is not necessary to use an ozonized water as recommended by the teaching of patent application WO 01/43556.

Following the prehumidification, the grains are left to stand for a so-called “rest” phase before the ozone treatment. The Applicant has found that this rest phase must last at least 1 day. In fact, it has been found that an insufficiently long rest period shorter than about 24 hours does not allow the ozone, during the treatment, to reach the core of the grain and hence to produce the desired effects. The rest period actually has a direct action on the penetration of the moisture and consequently on the subsequent action of the ozone inside the grain. Modulating this period modulates the effects of the ozone.

Although the process according to the invention is capable of giving technically acceptable results with rest periods in excess of 72 h, concern for making economically efficient use of the reactor is such that the chosen rest period is less than or equal to 72 hours. The rest period will therefore preferably be between 1 and 3 days. Particularly preferably, the rest period of the process of the present invention will be between 36 and 48 hours.

After the rest phase, the grains are subjected to a specific treatment in which they are exposed to ozone in a continuously stirred reactor, as described in patent application WO 01/43556.

Advantageously, the gas used here will be a dry ozone-containing gas with a dew point of between −60 and −80° C. This gas can be produced by conventional processes from carrier gases, which can be atmospheric oxygen, pure oxygen or a mixture of the two. A dry ozone-containing carrier gas can be produced from a dry oxygen source using an ozonizer.

The amount of ozone used is between 6 and 20 g/kg of grains and preferably between 7 and 13 g/kg of grains. Of course, the precise amount depends on the nature of the wheat and the expected results.

If a carrier gas is used, the concentration of ozone in the carrier gas is typically between 60 and 200 g/m³ NTP and preferably between 80 and 140 g/m³ NTP.

The pressure of ozone-containing carrier gases in the reactor during the treatment is typically between 200 and 1100 mbar and preferably between 600 and 800 mbar.

Those skilled in the art will be able to choose an appropriate exposure time for the ozone treatment according to the concentration and pressure of ozone in the reactor. This time will generally be in the order of thirty (30) to sixty (60) minutes.

The Applicant has observed that, within the scope of the exposure of the grain to ozone, an amount of so-called “complementary” water should be added to the grain. This amount of water is between 3 and 10% and preferably between 3 and 5%, based on the dry weight of the grains. The amount of water used can be determined with a mass flow meter or by another method well known to those skilled in the art. In view of the fact that the effect of the prehumidification step is to increase the moisture content of the grains to a value preferably of between 16 and 18%, the effect of adding “complementary” water will be to increase the moisture content of the grains to a value preferably of between 19 and 28% and particularly preferably of between 19 and 23%.

Advantageously, the water used for the so-called “complementary” humidification is added in the form of a mist of very fine droplets sprayed under pressure onto the grains in a sealed chamber, which can be the treatment reactor itself or an attached device. During this complementary humidification phase, the mass of grains must be agitated in such a way that the deposited liquid film is homogeneous and comes into contact with all the grains.

Preferably, the “complementary” water is added to the grains simultaneously with the exposure to ozone. “Simultaneously” is understood as meaning that the water is added during the actual reaction with ozone. Alternately, the water can be added a certain time before the ozone arrives in the reactor, this time being at most 10 minutes and preferably from 2 to 3 minutes before the ozone is introduced.

In one particularly preferred embodiment of the present invention, the water used for complementary humidification contains a pH modifier.

The Applicant has in fact discovered that modification of the pH of the water used for complementary humidification is a particularly valuable way of modulating at will the physicochemical properties of the flours derived from the grain treatment process according to the invention. Thus the use of a substance for bringing the pH to a basic value of between 8 and 12 generally makes it possible to increase the viscosity of the dough. In such a case, the water used for complementary humidification can be rendered basic with a base that is approved for use in an agri-foodstuffs context, such as food-grade sodium hydroxide, sodium carbonate or sodium bicarbonate.

It may also be of value to have doughs of lower viscosity, the Applicant having shown that the use of a pH of 3 to 6 for the water used for complementary humidification is particularly beneficial in this case. Acids for attaining this pH which are approved for use in the agri-foodstuffs sector include e.g. citric acid, acetic acid or any food-grade weak acid.

Methods of Measuring the Physical and Chemical Properties of the Flours Resulting from the Ozone Treatment

To confirm the value of the process which has now been described, the Applicant used and developed several methods of measuring physical and chemical properties which made it possible to evaluate the suitability of the flours obtained for use in processes for the manufacture of products for human consumption by the cereal cooking industry.

Thus:

1) The mechanical properties of a dough during rising (extension, tenacity, swelling) and during baking (porosity, collapse on cooling) were evaluated by means of the Chopin-Dubois alveograph.

2) The change in the viscosity of a flour-containing solution during a heat treatment following by cooling was studied by the so-called RVA (rapid viscosity analysis) method; other means of measurement, particularly a Brabender viscometer, can be used for this purpose.

3) The color of the crumb of the products obtained from flours was monitored with time by comparison with that of fresh controls.

4) The keeping time, in the presence of air, of the flours obtained after the wheat grain ozone treatment according to the present invention was studied by measuring the fatty acidity.

5) Methods of chemical analysis were also used to monitor the biochemical change in the grains. In particular, the maltose content of the grains was monitored and the appearance of MDA (malonic dialdehyde) was measured. The appearance of maltose is an index reflecting starch hydrolysis. The natural concentration of maltose in the grains is in the order of 300 mg/100 g of grains and a maltose content very much greater than this value indicates a degree of starch metabolism. On the other hand, the appearance of MDA correlates with the activity of enzymes that participate in oxidizing processes.

Examples of parameters of the wheat grain ozone treatment are collated in Table 1. Five batches of wheat grains were treated with ozone while different parameters of the process, especially the rest period, the amount of complementary water added and the pH of this water, were varied. The results of the viscosity, alveogram and other measurements are given for each choice of process parameters. A comparison with a wheat sample which has not undergone ozonization is also shown.

The test wheats were mixtures of different wheat varieties that are well known for bread making. In other series of experiments, superior pure varieties suitable for bread making were treated; in this precise case, the Applicant obtained results of the same nature as those given below.

TABLE 1
Examples of products subjected to measurements

| | | | Control | Treatment 1 | Treatment 2 | Treatment 3 | Treatment 4 | Treatment 5 |
|---|---|---|---|---|---|---|---|---|
| Treatment parameters | | | | | | | | |
| % of complementary | 2% | | | X | | | X | |
| water added, based on | 4% | | | | X | X | | X |
| dry weight of grains | | | | | | | | |
| Rest period | 24 | h | | X | | | | X |
| | 48 | h | | | X | X | X | |
| Dose of O₃ in g/kg | 3 | | | X | | | | |
| of grains | 5 | | | | | | X | |
| | 10 | | | | X | | | X |
| pH of complementary | 12 | | | | X | | | |
| water | 4 | | | | | X | | |
| | 7 | | | X | | | X | X |
| Ozone pressure | 350 | mbar | | X | | | X | X |
| in reactor | 800 | mbar | | | X | X | | |
| Measurements made | | | | | | | | |

| | | | | | | | |
|---|---|---|---|---|---|---|---|
| RVA viscosity | Peak | 150 | 170 | 215 | 190 | 200 | 210 |
| | Plateau | 170 | 185 | 255 | 210 | 225 | 240 |
| Chopin-Dubois | P (mm of | 64 | 70 | 97 | 100 | 83 | 93 |
| alveogram | water | | | | | 68 | 40 |
| | column) | | | | | | |
| | L (mm) | 85 | 79 | 26 | 23 | 1.22 | 2.33 |
| | P/L | 0.75 | 0.89 | 3.73 | 4.35 | 178 | 148 |
| | W (10⁻⁴ J) | 187 | 186 | 124 | 104 | | |

| | | | | | | |
|---|---|---|---|---|---|---|
| Amylase content (mg/100 g) | 220 | 2120 | 957 | 788 | 1316 | 1043 |
| MDA (oxidation of lipids in | 590 | 560 | 450 | 490 | 470 | 430 |
| μg/100 g) | | | | | | |

### RESULTS

1) Effects of the Ozone Dose on the Measurement of the Chopin-Dubois Alveograph

The Chopin-Dubois alveograph is a test based on the following observations: when the bread rises, a multitude of small bubbles of carbon dioxide (CO₂) form within the dough, constituting alveoli that vary in size and number according to the plasto-elastic properties of the gluten retaining them.

The experiment therefore consists in artificially reproducing this phenomenon by subjecting a disk-shaped sample of dough, under well-defined conditions (application time, temperature, hydration) to an air pressure in order to measure their extensibility.

The apparatus records a graph which can be interpreted in the following manner:

the height of the curve, which measures the maximum air pressure P in the dough, determines the deformation resistance of the gluten. It represents the tenacity of the dough. The higher the value of P, the more the dough resists and, in the extreme case, retracts on elongation;

the length of the curve, L, determines the time for which the gluten can be deformed without yielding. The length L represents the extensibility. The greater the value of L, the more the dough will stretch easily without breaking. This value is related to the swelling G of the bubble;

W (area under the curve) corresponds to the deformation work based on one gram of dough. It expresses the “baking strength”;

the PAL ratio alone summarizes the balance between the tenacity P and the extensibility L of the gluten.

It is considered that, to a first approximation, the alveograph measurement concerns the proteins. It is known that the kneading of a flour in the presence of water introduces atmospheric oxygen. This oxidizes the proteins in the flour (the gluten) and allows the formation of transitory protein aggregates, which cause the creation of a network that will mechanically support the dough and give it stability during the rising phase.

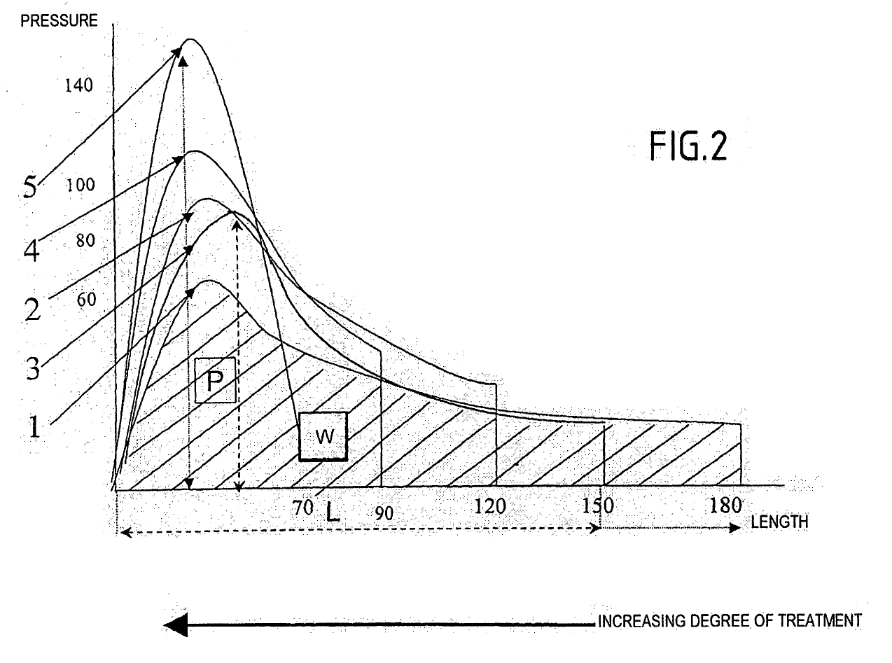

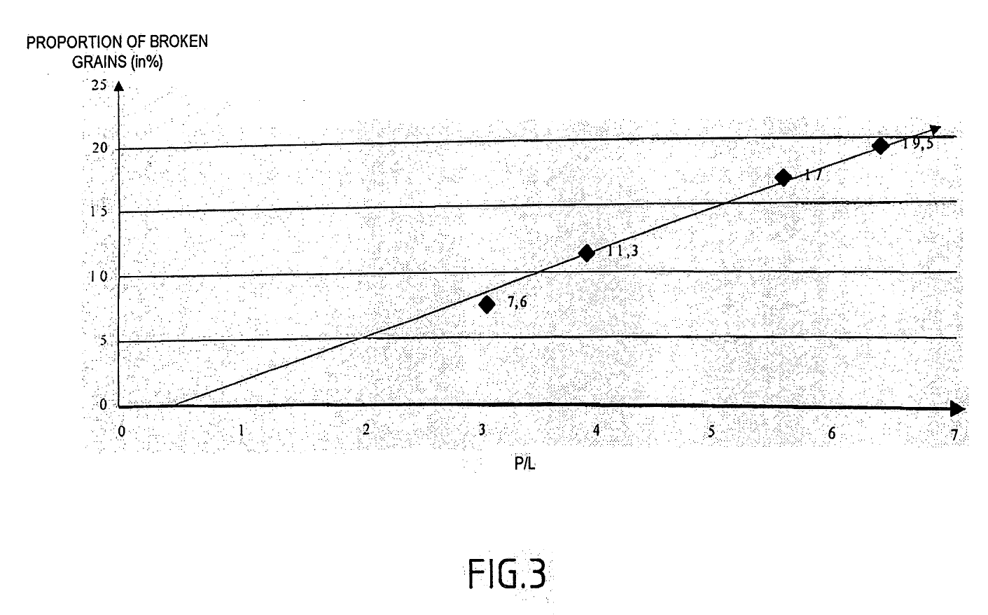

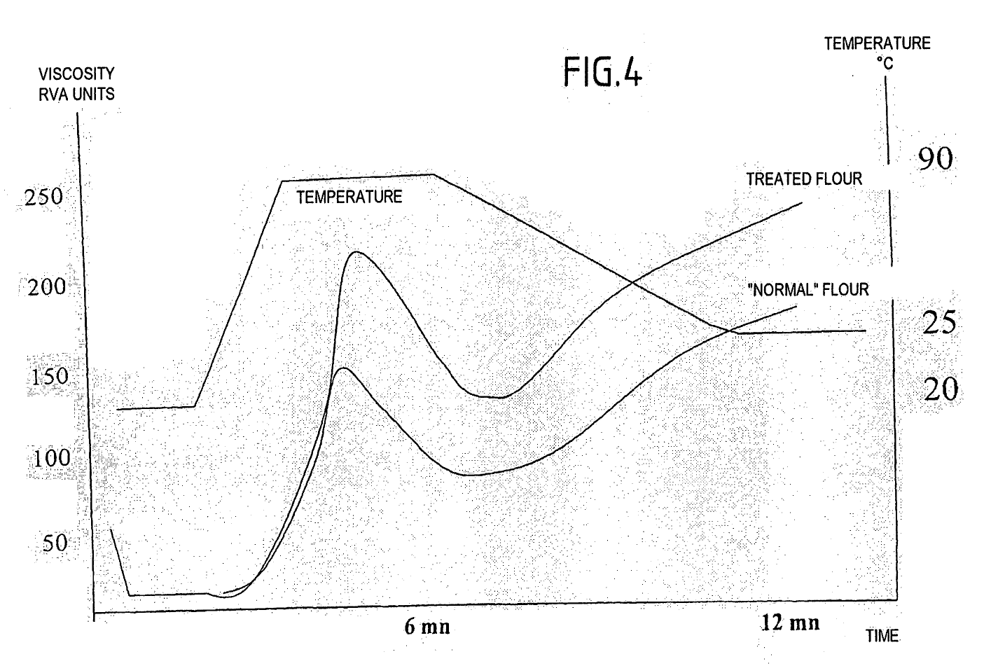

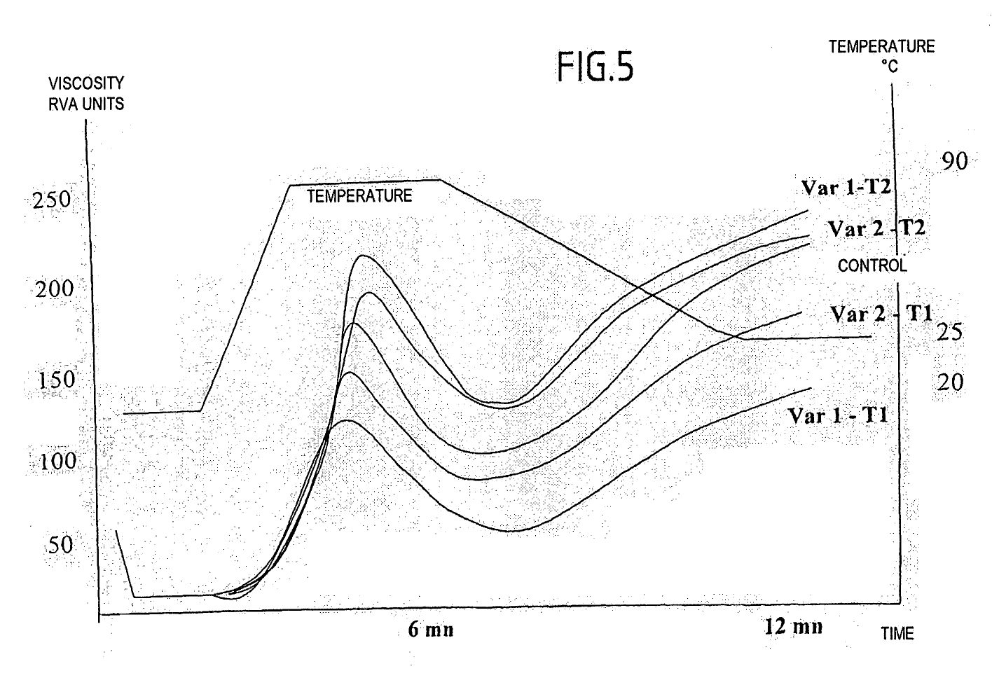

FIG. 2 represents the impact of the ozone dose on the alveogram obtained by means of the Chopin-Dubois alveograph, all the other parameters of the process being equal.

The P/L ratio (where “P” is the pressure to which the dough is subjected and “L” is the elongation of the dough) is seen to increase uniformly as a function of the ozone dose applied. The curve identified by 1 corresponds to a conventional, well-balanced flour not treated with ozone.

When low ozone doses are used, the dough becomes more tenacious. The curve identified by 2 thus corresponds to a dough obtained from flour derived from grains pretreated with ozone and having a higher tenacity and a lower extensibility than the dough identified by 1. It should be noted that this modification of the alveogram is very similar to that obtained by adding ascorbic acid. It is very interesting to note in this context that prior treatment of the grain with ozone makes it possible to dispense with the addition of ascorbic acid before kneading, thereby satisfying the aforementioned desire to avoid the use of additives.

Curves 3 and 4 correspond to the alveogram of doughs obtained from flours derived from grains which have been pretreated with an increasing dose of ozone and/or whose humidification has been varied. These curves perfectly represent the action of ozone on the tenacity parameter as well as the extensibility parameter. At a higher ozone dose, the doughs therefore become more tenacious, but also slightly porous. In this instance, they afford an improvement in the baking stability of so-called “high ratio” English cakes or Genoese cakes, a criterion sought by industrialists.

At a very high ozone dose, the alveogram loses its plateau and its dissymmetry and takes on the shape of a peak similar to that observed for chlorinated flours.

Curve 5 corresponds to a dough manufactured from so-called “technological” flour derived from grains which have been pretreated with ozone under the optimal conditions of protein modification. Curve 5 corresponds specifically to the theoretical curves sought for the manufacture of so-called “high ratio” English cakes. This curve has a maximum tenacity equal to or greater than 150, and a minimum extensibility. In this last case, the gluten modified by ozone has a very low extensibility and at the same time a high porosity. This characteristic enables it to be neutral in the manufacture of products rich in sugar, other proteins and fats, and to avoid excessive swelling during baking, followed by collapse on cooling. Such a flour produces a cake which rises more slowly and holds its shape after rising, but does not collapse after cooling.

2) Determination of the Maltose Derived from Starch Hydrolysis

It has been observed by the Applicant that the consequence of the wheat grain ozone treatment according to the invention, insofar as the ozone penetrates correctly inside the grain, is slightly to hydrolyze the starch. This starch hydrolysis can be represented by the appearance of a maltose peak in the analyses.

The maltose is determined as part of a general determination of the sugars. The sugars are separated on a polymer anion exchange column optimized for sugar analysis, this column operating at basic pH. The sugars, whose pKa varies between 12 and 14, are then in their anionic form and interact selectively with the amino-latices of the resin.

The principle of detection is an electrochemical oxidation reaction: the current created is proportional to the sugar concentration.

Melibiose is used as an internal standard to compensate the variations in electrochemical responses due to the mobile phase, the temperature and the nature of the injected sample.

The maltose content of treated wheats was compared with that of control wheats. The natural concentration of maltose in the grain of an untreated wheat is in the order of 300 mg/100 g of grains. This maltose content can reach a maximum of 2000 mg/100 g of grains after an ozone treatment under the conditions described in the above paragraphs. The appearance of this peak indicates a degree of starch metabolism. An ozone treatment under the optimal conditions discovered by the Applicant generally induces a starch hydrolysis that corresponds to a mass change in the starch of between 1 and 5% and preferably of the order of 3%. The starch hydrolysis produces a sufficient amount of maltose to allow yeast development and, consequently, makes it possible to dispense with the addition of amylase.

3) Study of the Ozone Treatment of Homogeneous Batches of Wheats Containing an Artificially Increased Proportion of Broken Grains

The Applicant assembled homogeneous batches of wheats in which the proportion of broken grains had been artificially increased (by mechanical action) prior to the ozone treatment. The proportion of broken grains was initially increased for research purposes, but modulation of the proportion of broken grains can also constitute an industrially applicable means of controlling the physical and chemical properties of the flours resulting from the process of the present invention.

From the research point of view, as the contents of the broken grains are in direct contact with ozone inside the grain during its treatment, their use affords a better understanding of the nature of the reactions caused by ozone.

The grains treated with ozone, in which the proportion of broken grains had been increased, were ground by the flour milling process, i.e. the broken grains and the still intact grains were ground together, and the alveogram was obtained in order to calculate the P/L value of the resulting flour. An example of the variation in the P/L ratio induced by a change in the proportion of broken grains is shown in FIG. 3.

FIG. 3 represents the impact of the proportion of broken grains on the change in the P/L ratio obtained by means of the Chopin-Dubois alveograph. To do this, the Applicant broke a variable percentage of grains, added these grains to unbroken grains and then treated the whole with constant doses of ozone. The flours obtained after milling were tested by means of the Chopin-Dubois alveograph and the P/L ratio was calculated.

The Applicant observed that the slope of the line was very dependent on the wheat variety used. An analysis of graph no. 3 allows the following interpretations:

for a 0% proportion of broken grains (not counting either the cracked grains or the very slightly damaged grains, which cannot be evaluated), the modification of P/L is in the order of 0.5, which is less than would be obtained after the addition of 100 mg of ascorbic acid/kg of flour for one and the same wheat variety. The next four points correspond to:

| | |
|---|---|
| P/L = 3 | Proportion of broken grains: 7.6% |
| P/L = 3.9 | Proportion of broken grains: 11.3% |
| P/L = 5.6 | Proportion of broken grains: 17.0% |
| P/L = 6.4 | Proportion of broken grains: 19.5% |

This curve can be interpreted as follows:

the broken grains offer the ozone action a direct accessibility, favoring the chemical reactions between the ozone and the proteins. When the dough is manufactured and hydrated, the gluten network, oxidized with ozone beforehand, therefore has a greater tenacity, which explains the increase in P/L as a function of the percentage of broken grains;

the broken grains offer the ozone action a direct accessibility, favoring the chemical reactions between the ozone and the starch. Consequently, less water is available for the proteins, which linearly favors the tenacity of the gluten network. As ozone favors the absorption of water by the starch during kneading, the relative hydration of the gluten is reduced in the case of ozone treatment, giving rise to a high P/L ratio.

4) Study of the Viscosity of the Flour Solutions Over Time

The Applicant has discovered that it is very advantageous, for evaluation of the physical and chemical properties of the flours, to study the change in the viscosity of an aqueous flour solution with time.

FIG. 4 represents the impact of ozone treatment on the viscosity of a solution containing flour in a well-defined solids concentration, as a function of time and according to a process of temperature rise, stabilization and then cooling.

This Figure shows two curves corresponding to a normal, untreated flour and a flour treated according to the parameters claimed in the present patent application.

The curve labeled “temperature” shows the change in the temperature to which the sample containing the flour is subjected during the test. The far left section of the temperature curve corresponds to the temperature at the start of the test, i.e. room temperature (about 20° C.), and the second section of the curve corresponds to the gradual rise in temperature of the sample subjected to the test, up to a maximum of 90° C. The plateau, which forms the third section of the curve, corresponds to maintenance of the temperature of the sample during the viscosity measurement. The fourth, falling section of the curve corresponds to the withdrawal of heat and to the drop in the temperature of the sample due to controlled cooling down to a stabilizing equilibrium value above room temperature (about 25° C.).

The curves obtained for the normal flour and the treated flour correspond to the measured values of the viscosity in RVA units, it being indicated that one RVA unit is equal to ten centipoises.

It is observed from these curves that ozone treatment of the grains prior to milling considerably increases the viscosity of the corresponding flour solutions. This viscosity increase is induced by the action of the ozone on the starch and probably also on certain amylases.

These curves clearly demonstrate that the ozone has penetrated deep inside the grains to react with the albumen constituents (in this instance, starch).

FIG. 4 makes it possible to compare a flour treated by the process of the present invention with a normal flour, both analyzed according to a procedure called RVA (rapid viscosity analysis). The Figure shows not only that the curve is modified, but also, in particular, that the final viscosity of a treated flour is considerably greater than that of an untreated flour. It may be considered that, at least in part, the changes to the viscosity profiles of the flour solutions result from the modifications to the starch. On the one hand, ozone can cause starch to crosslink, directly increasing the viscosity as a consequence. On the other hand, amylase, a starch-hydrolyzing enzyme, is inhibited by ozone.

Insofar as the ozone penetrates correctly inside the grain, it can act on the enzymes, which are preferentially stored in the aleuron layer (cf. FIG. 1). Modification of the amylase by ozone causes a change in conformation of the amylase and the suppression of a high percentage of its activity. This inhibition of the amylase was also demonstrated by the so-called “Hagberg time” method.

5) Effect of Ozone on Polyphenol Oxidase, Lipase and Lipoxygenase

It has been observed that, under the conditions defined within the framework of the present invention, ozone inhibits enzymes other than amylase. The direct consequence of the inhibition of polyphenol oxidase, lipase and lipoxygenase by ozone is an effect on the color of the crumb of the products obtained from flours derived from grains pretreated with ozone. In the case of an ozone treatment, the crumb is paler and the resulting flours keep much better. It has also been observed by the Applicant that the keeping time, in the presence of air, of flours derived from grains pretreated with ozone increases by 60 to 80%, or in some cases by more than 100%. This is explained by the inhibition of lipase by ozone, which favors a stabilization of the flours, and by the absence of oxidation of the natural fatty acids.

6) Effect of Ozone on the Appearance of MDA (Malonic Dialdehyde)

MDA is considered to be a marker for the peroxidation of polyunsaturated fatty acids having at least two double bonds.

The total MDA is determined by reaction with thiobarbituric acid (TBA). The complex formed between one molecule of MDA and two molecules of TBA can then be measured either by spectrophotometry or by reverse phase HPLC. The reaction with TBA is not specific to MDA and the determination by spectrophotometry may be subject to interferences. Its results are usually expressed in TBARS, or TBA-reactive substances. This interference problem is eliminated if the TBA-MDA complex is determined by reverse phase HPLC.

Using a conventional method of laboratory analysis, MDA determinations were performed on flours derived from the milling of grains after they had been treated with ozone according to the invention. The amounts of ozone used are between 5 and 12 g of ozone/kg of wheat. It was observed that the MDA decreases after treatment as a function of the degree of humidification of the grains, and decreases proportionately to the ozone dose applied. The decrease in MDA is significant, being typically in the order of 15 to 25%.

As the appearance of MDA is an index of the activity of oxidizing enzymes, these results confirm that, provided the ozone penetrates sufficiently inside the grain, the ozone treatment slows down the oxidizing process, probably by acting on the enzymes that take part in it.

The ozone treatment according to the present invention therefore has a stabilizing effect on the oxidizing processes. The absence of lipoxygenase activity confirms the absence of lipid oxidation.

7) Effect of the pH of the Mater Used for Complementary Humidification

It was observed that the impact of ozone on the grains was very dependent on the pH of the water used for complementary humidification of the wheat grains, carried out simultaneously with the exposure to ozone. It proved very valuable in this context to study, by the RVA method, the change in viscosity with time during a heat treatment. FIG. 5 shows the different viscosity profiles of the flours obtained by the ozone treatment of grains which have been subjected to a complementary humidification with aqueous solutions of different pH values.

FIG. 5 represents the impact of the pH of the complementary humidifying water in the grains on the viscosity of a flour obtained from grains treated by a deep-acting process, this viscosity being studied by the RVA method in the same way as for the experiments represented in FIG. 4.

The curves showing the variation in viscosity relate to two characteristic varieties of soft wheat, variety 1 being soft wheat of the Courtot type, i.e. a strong wheat, and variety 2 corresponding to a wheat of the Shango type, i.e. a common soft wheat suitable for bread making. The control corresponds to a mixed wheat for ordinary bread making.

The increase or decrease in viscosity is very dependent on the variety of wheat treated, each variety having a specific behavior.

It is found that, at basic pH, there is a substantial increase in the viscosity of the dough. To make more viscous doughs, the Applicant's studies showed that the pH range of the water used for complementary humidification was preferably between 8 and 13 and particularly preferably from 8.5 to 9.5.

At acidic pH, on the other hand, the viscosity is seen to decrease relative to a control at neutral pH. The Applicant's experiments showed that the preferred pH range for the manufacture of less viscous doughs was between 3 and 6.

Without wishing to be bound by any one theoretical interpretation, the Applicant is of the opinion that, under basic conditions, ozone gives rise to a reactivity of the free radical type that is capable of causing the starch to crosslink and, consequently, the viscosity to increase. The studies demonstrated that at acidic pH, on the other hand, the starch could be cleaved by action on the double bonds or the bonds between monomers, thereby suppressing the crosslinking phenomenon and hence reducing the viscosity.

These curves together show that the ozone acts at depth, since the starch contained in the albumen becomes modified.

### GENERAL CONCLUSION

Taken together, the observations summarized above show that, in a treatment under specific conditions, it is possible to cause ozone to penetrate deep inside the tissues, or even cells, of an unground plant material such as wheat grains. No method has yet been described which makes it possible to cause a reactive gas to penetrate inside plant structures, such as grains or other intact tissues, before grinding. The Applicant's discoveries have demonstrated that, provided a sufficient rest period is allowed and the humidification of structures such as wheat grains is controlled, it is possible to cause ozone to penetrate to the core of such structures.

All applications that demand an increase in the viscosity of a dough produced from a wheat flour, and simultaneously a more porous gluten allowing the baking gases to escape by passing through the mass of dough without creating blisters, benefit from this type of treatment. These are any applications associated with breadcrumbs and coating, but also, as indicated previously, the manufacture of English cakes, Genoese cakes and other products containing sugar, as well as any cakes having an emulsified structure, i.e. containing fat, water and emulsifiers, one of the standard examples of such cakes in North America being yellow layer cake.

1. A method for treating an unground plant material which comprises the steps of:
a) prehumidification of said plant material by the addition of a volume of water;
b) a rest phase for said humidified plant material; and
c) exposure of said plant material to ozone,
wherein said rest phase has a duration greater than or equal to 1 day, and wherein the ozone treatment is carried out with a dry ozone-containing gas, said ozone treatment comprising a complementary humidification carried out simultaneously with, or at most 10 minutes before, said exposure to ozone under conditions that make it possible to add from 3 to 10% by weight of water to said plant material, based on the dry weight of the material.

2. A method according to claim 1 in which the plant material comprises soft wheat grains.

3. A method according to claim 1 in which the plant material comprises hard wheat grains.

4. A method according to claim 1 in which the water used for complementary humidification is non-neutral and comprises a pH modifier.

5. A method according to claim 4 in which the pH of the water used for complementary humidification is between 3 and 6.

6. A method according to claim 5 in which the acidity of the water used for complementary humidification is provided by citric acid, acetic acid or any other food-grade weak acid.

7. A method according to claim 4 in which the pH of the water used for complementary humidification is between 8 and 12.

8. A method according to claim 7 in which the basicity of the water used for complementary humidification is provided by food-grade sodium hydroxide, sodium carbonate, sodium bicarbonate or any other food-grade basic product.

9. A method according to claim 1 in which the rest period is between 24 and 72 hours.

10. A method according to claim 1 in which the water used for complementary humidification is added to the plant material in the form of a mist consisting of fine droplets produced by spraying the water under pressure.

11. A method according to claim 1 in which 3 to 5% by weight of a water, based on the grains, is added during the prehumidification in order to increase the moisture content of the grains to a value of between 16 and 18%.

12. A method according to claim 1 in which broken grains are introduced prior to prehumidification, the amount of broken grains being between 0.5 and 20%.

13. A method according to claim 1 in which the amount of ozone used is between 6 and 20 g of ozone/kg of plant material.

14. A method according to claim 1 in which the concentration of ozone in the ozone-containing carrier gas is between 60 and 200 g/m³ NTP.

15. A method according to claim 1 in which the pressure of the ozone-containing gas is between 200 and 1100 mbar.

16. A method for the manufacture of flours which comprises treating soft wheat grains with ozone according to claim 1, and which comprises an additional step for grinding the treated grains.

17. A method according to claim 16 in which the parameters of the process for the treatment of soft wheat grains are chosen in such a way that, after the grain grinding step, the viscosity of the resulting flour is increased by between 10 and 50%, relative to a flour derived from untreated grains, and the P/L ratio of the flour is greater than 2.5.

18. A flour produced by a process according to claim 17.

19. A method for the manufacture of semolinas or pastas which comprises treating hard wheat grains with ozone according to claim 1, and which comprises an additional step for grinding the treated grains.

20. A method according to claim 1 in which the plant material includes seeds of a leguminous plant.

21. A method according to claim 1 wherein the complementary humidification is carried out under conditions that make it possible to add from 3 to 5% by weight of water to said plant material, based on the dry weight of the material.

22. A method according to claim 9 wherein the rest period is between 36 and 48 hours.

23. A method according to claim 12 wherein the amount of broken grains is between 3 and 10% of the total weight of the grains.

24. A method according to claim 13 wherein the amount of ozone used is between 7 and 13 g of ozone/kg of plant material.

25. A method according to claim 14 wherein the concentration of ozone in the ozone-containing carrier gas is between 80 and 140 g/m³ NTP.

26. A method according to claim 15 wherein the pressure of the ozone-containing gas is between 600 and 800 mbar.

27. A method according to claim 17 wherein the P/L a ratio of the flour obtained after grinding treated soft wheat grains is greater than 3.5.

28. A method according to claim 20 wherein the leguminous plant is selected from the group consisting of soya, pea, carob, guar, colza, cabbage and flax.

29. A flour produced by a process according to claim 27.
